(19) United States
(12) Patent Application Publication
(10) Pub. No.: US 2026/0140749 A1
(43) Pub. Date: May 21, 2026

(54) ARTIFICIAL INTELLIGENCE DRIVEN USER SUPPORT SYSTEM

(71) Applicant: DevRev, Inc., Palo Alto, CA (US)

(72) Inventor: Ribhu Chawla, Bengaluru (IN)

(73) Assignee: DevRev, Inc., Palo Alto, CA (US)

(21) Appl. No.: 18/949,920

(22) Filed: Nov. 15, 2024

(51) Int. Cl. G06F 9/451

(52) U.S. Cl. CPC G06F 9/453

(57) ABSTRACT

Disclosed is an artificial intelligence (AI)-driven user support system for a platform. The system includes at least one user interface configured to facilitate user interaction of a user with the system. The user interface is further configured to receive user inputs corresponding to a desired task to be performed on the platform. The system also includes an AI-driven support module configured to provide support to the user in response to the user inputs. The system also includes an AI training module configured to track real-time user interaction data of the user with the AI-driven support module. The AI training module is also configured to track the analytics and application usage data of the platform. The AI training module is also configured to facilitate real-time training of the AI-driven module based upon the tracked user interaction data and analytics and application usage data to provide multi-modal support to the user.

### FIELD OF INVENTION

Embodiments of the present disclosure pertain to an artificial intelligence, and more particularly to, a system designed for delivering an intelligent user support system.

### BACKGROUND

In today's rapidly evolving digital landscape, platforms and software applications are becoming increasingly complex and feature-rich. As a result, users often encounter difficulties in navigating these systems, leading to frustration and decreased productivity. Traditional user support methods, such as static help documentation, FAQs, and human-operated call center, often fall short in addressing these challenges. They tend to be reactive rather than proactive and struggle to keep pace with frequent updates and changes in software interfaces and functionalities.

The rise of artificial intelligence (AI) has opened new possibilities for creating more effective and responsive user support systems. AI-driven support systems can leverage machine learning and natural language processing to understand user intents, predict needs, and offer personalized assistance. These systems can analyze vast amounts of user interaction data and application usage patterns in real-time, enabling them to provide contextually relevant support that is tailored to each user's unique situation.

Despite the potential of AI, many existing AI-driven support systems still face limitations. They often rely on pre-defined responses and lack the capability to adapt dynamically to changes in user interfaces and application features. As platforms evolve, these systems can become outdated, leading to inaccuracies and inefficiencies in support delivery. Furthermore, they may offer limited support modalities, such as text-based responses, which may not be sufficient for all user scenarios.

To address these limitations, there is a growing need for an AI-driven user support system that can continuously learn and adapt based on real-time data. Such a system should be capable of recognizing and responding to changes in the platform, such as interface updates or the introduction of new features. It should also support multiple modes of assistance, including text responses, visual guides, and interactive help, to accommodate diverse user preferences and needs.

### SUMMARY

The following description is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, an artificial intelligence (AI)-driven user support system for a platform is provided. The system includes at least one user interface configured to facilitate user interaction of a user with the system. The user interface is further configured to receive user inputs corresponding to a desired task to be performed on the platform. The system also includes an AI-driven support module configured to provide support to the user in response to the user inputs. The system also includes an AI training module configured to track real-time user interaction data of the user with the AI-driven support module. The AI training module is also configured to track the analytics and application usage data and website design and structure of the platform. The AI training module is also configured to facilitate real-time training of the AI-driven support module based upon the tracked user interaction data and analytics and application usage data to provide multi-modal support to the user.

According to another example embodiment, an artificial intelligence (AI)-driven user support system for a platform is provided. The system includes a memory storing one or more processor-executable routines and a processor communicatively coupled to the memory. The processor is configured to execute one or more processor-executable routines to receive user inputs corresponding to a desired task to be performed on the platform via at least one user interface. The processor is further configured to provide support to the user in response to the user inputs via an AI-driven support module. The processor is further configured to track real-time user interaction data and analytics and application usage data of the platform. The processor is further configured to train the AI-driven support module via an AI training module based upon the tracked user interaction data and analytics and application usage data to provide multi-modal support to the user.

According to another example embodiment, a method for training an artificial intelligence (AI)-driven user support system is provided. The method includes interacting with a user of the system via at least one user interface. The method further includes providing responses to the user in response to one or more user inputs received via the user interface. The method further includes tracking real-time user interaction data of the user. The method further includes tracking analytics and application usage data of the system. The method further includes dynamically training the system based upon the tracked user interaction data and analytics and application usage data.

### BRIEF DESCRIPTION OF THE DRAWINGS

The disclosure will be described and explained with additional specificity and detail with the accompanying figures in which:

FIG. 1 is a block diagram representation of an artificial intelligence (AI)-driven user support system;

FIG. 2 is a flow chart illustrating the method for training an artificial intelligence (AI)-driven user support system;

FIG. 3 is a flow chart illustrating the workflow of an artificial intelligence (AI)-driven user support system; and

FIG. 4 is a block diagram of an embodiment of a computing device in which the modules of the artificial intelligence (AI)-driven user support system, described herein, are implemented.

### DETAILED DESCRIPTION

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between the first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

This section will describe an illustrative architecture to provide artificial intelligence (AI)-driven user support by dynamically leveraging artificial intelligence (AI).

Embodiments of the invention provide an AI-driven user support system for a platform that offers comprehensive and dynamic end-to-end assistance to users. These embodiments address significant challenges of conventional user support systems that often lack real-time, context-sensitive assistance and require users to navigate separate interfaces or resources. The AI-driven support system is designed to seamlessly integrate real-time support with user interactions by leveraging advanced AI training modules that track real-time user interaction data, analytics, and application usage data. This integration allows users to receive immediate, tailored guidance, significantly enhancing overall efficiency and user satisfaction by bridging the gap between user assistance and the operational aspects of the system.

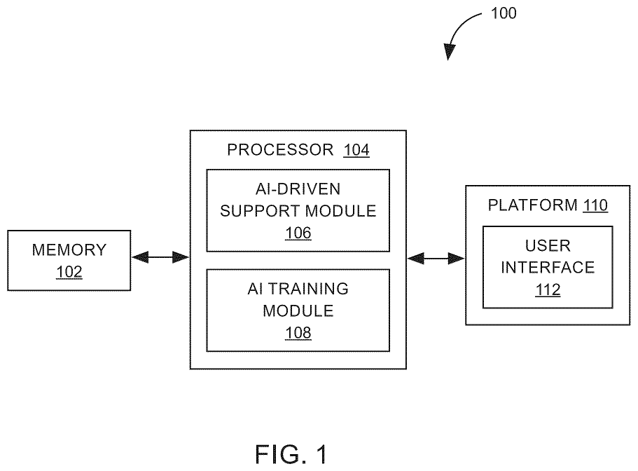

FIG. 1 is a block diagram 100 illustrating an artificial intelligence (AI)-driven user support system for a platform 110 in accordance with embodiments of the invention. The system 100 includes a memory 102, and a processor 104. The memory 102 is configured to store one or more processor-executable routines and the processor 104 is communicatively coupled to the memory 102 and is configured to execute the one or more processor-executable routines. The processor 104 is further configured to facilitate AI-driven user support for the platform 110. In the example embodiment, the platform 110 includes a user interface 112 that is configured to facilitate user interaction of a user with the system 100. The user interface 112 is configured to receive a user input corresponding to a desired task to be performed on the platform 110.

In another example embodiment, the processor 104 includes an AI-driven support module 106 and an AI training module 108. The AI-driven support module 106 is configured to provide support to the user in response to the user inputs for the desired task. The AI training module 108 is configured to track real-time user interaction data and platform analytics to continuously train the AI-driven support module 106, enabling it to deliver adaptive, multi-modal support in real-time.

The AI-driven user support system 100, as described in the above embodiment, comprises the AI-driven support module 106 designed to offer dynamic and responsive assistance to users interacting with a platform 110. The AI-driven support module 106 is configured to receive user inputs via a user interface 114 and subsequently provides context-sensitive, real-time support to assist users in performing their desired tasks on the platform 110. The AI-driven support module 106 functions as the primary interactive interface between the user and the platform 110, leveraging machine learning models and AI algorithms to deliver tailored responses based on user behaviour, platform context, and other relevant factors.

Additionally, the system 100 incorporates the AI training module 108 that is configured to facilitate continuous improvement and adaptation of the AI-driven support module 106. The AI training module 108 is configured to track real-time user interaction data within the AI-driven support module 106 and to gather analytics and application usage data from the platform 110. Additionally, it can analyze website design (HTML) and structure to provide a comprehensive understanding of the platform's user experience. By aggregating these data points, the AI training module 108 is capable of performing real-time training of the AI-driven support module 106, allowing it to continuously evolve and refine its responses based on the latest interaction and usage patterns. This real-time training empowers the AI-driven support module 106 to provide more accurate and efficient multi-modal support, ranging from textual guidance to visual guides and interactive responses.

In further embodiments, the AI training module 108 is capable of training the AI-driven support module 106 using both supervised and unsupervised learning models. Supervised learning allows the AI-driven support module 106 to learn from labelled data, often in the form of explicit feedback or predefined examples, while unsupervised learning enables the AI-driven support module 106 to identify patterns within the interaction data autonomously. These learning models allow the system to progressively improve without the need for constant manual intervention, significantly reducing the operational burden of maintaining the system and enhancing its adaptability to changing user needs.

Furthermore, the AI training module 108 is configured to monitor dynamic changes within user interface 112 of the platform 110, such as the addition, removal, or modification of interface elements. As user interfaces evolve, the system automatically updates the support documentation and assets associated with the AI-driven support module 106. This ensures that the guidance provided to users remains accurate and relevant, regardless of changes to the interface. The ability to monitor and respond to dynamic changes in real-time further enhances the system's reliability, particularly in fast-moving environments where user interfaces are frequently updated.

In operation, the AI training module 108 also plays a crucial role in understanding the context and functionality of the user interface 112. By analyzing the layout and behaviour of various interface elements, the system is able to provide context-aware support that is specific to the user's current environment. For example, if a user is interacting with a specific feature or tool within the platform 110, the system can provide targeted guidance relevant to that feature, ensuring that the user receives assistance that is both timely and accurate.

The AI-driven user support system 100 is also capable to adapt the changes in functionality and feature updates within the platform 110. The AI training module 108 is configured to monitor analytics and application usage data, and when new features are introduced, the AI training module 108 autonomously updates the associated support documentation for the AI-driven support module 106. This ensures that the system remains updated with the latest capabilities of the platform 110, allowing it to guide users through newly introduced features without the need for extensive manual configuration or updates by administrators.

Additionally, the AI-driven user support system 100 is designed to accommodate various user access levels, distinguishing between admin-level and user-level interfaces. The AI training module 108 is configured to learn from these access-controlled interfaces, allowing it to tailor its support offerings accordingly. This capability is particularly beneficial in environments where different user roles have varying levels of access to platform 110 features.

In addition to tracking user interaction and platform 110 changes, the AI training module 108 is further configured to receive feedback directly from the users. This feedback loop is an essential aspect of the system's adaptability, as it allows users to provide real-time input on the quality and relevance of the support they receive. The AI training module 108 processes this feedback to further train and refine the AI-driven support module 106, ensuring that user preferences and issues are addressed promptly. The system can incorporate this feedback into both supervised and unsupervised learning models to improve future responses and overall support quality.

The AI-driven support module 106 is also designed to provide multi-modal responses to user inputs. These responses can include textual answers, visual guides, and interactive support, depending on the user's needs and the nature of their query. By offering a combination of response types, the system enhances the user experience, catering to different learning preferences and making the support more engaging and effective. For instance, a user seeking guidance on how to use a specific tool within the platform 110 may receive a step-by-step visual guide, while another user might be provided with interactive responses that walk them through a task in real-time.

Moreover, the learning capabilities of the AI-driven user support system 100 have broad applications beyond updating the knowledge base and providing multi-modal support. The AI training module 108 is configured to dynamically adjust the platform's onboarding experience in real-time as changes occur in the user interface 112. For instance, if a button or feature within the interface is repositioned from left to right, the system can detect this change and automatically update the corresponding tooltips, guides, and instructional elements to reflect the new location. This ensures that onboarding materials remain accurate and relevant despite ongoing UI modifications, providing users with a seamless and intuitive experience even as the platform evolves.

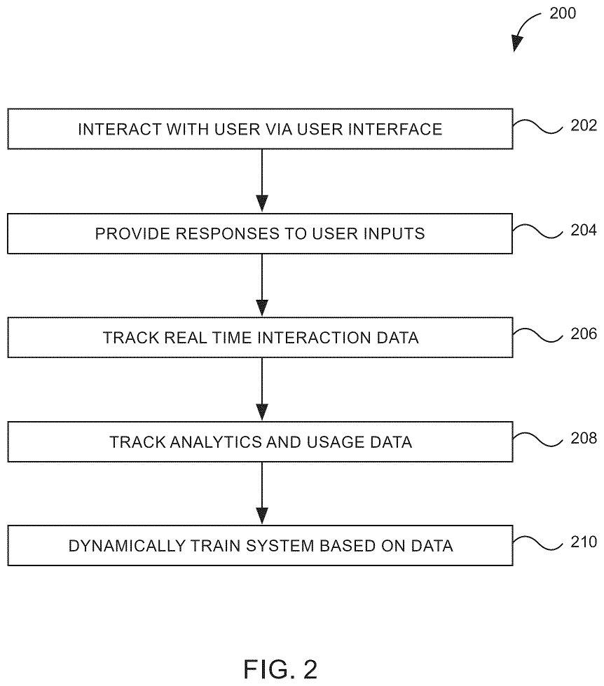

FIG. 2 is a flowchart 200 illustrating a workflow of the artificial intelligence (AI)-driven user support system 100 of FIG. 1 according to embodiments of the invention. At block 202, the system interacts with the user via at least one user interface. At block 204, the system responds to the user by analyzing one or more user inputs received through the user interface, providing targeted assistance in real-time. The system provides multi-modal support to the user in response to the user inputs. Multi-modal support refers to the system's ability to generate and deliver assistance through various formats, including but not limited to text responses, visual guides, interactive responses, and a combination thereof. This enables the AI-driven system to cater to diverse user preferences and requirements, ensuring that support is not limited to a single modality but adapts to the nature of the task and the user's specific context.

The method further includes tracking the real-time user interaction data, that includes the user's behaviour and engagement patterns with the platform (block 206). Additionally, the system collects and analyzes analytics and application usage data from the platform (block 208). This data serves as a vital input for dynamically training the AI-driven user support system (212). By integrating real-time user interaction data with analytics and usage data, the system continuously evolves its training, improving its ability to provide accurate and context-aware responses to the user.

The system detects one or more changes to one or more user interfaces (UI) of the system, adjusting the system's responses accordingly, and responses to the user inputs based on these changes. The AI-driven user support system is designed to dynamically adapt to alterations in the platform's user interface, ensuring that the guidance provided to the user remains accurate and relevant even as the UI evolves.

Additionally, the method further comprises updating one or more assets of the system based upon the detected changes to the user interfaces. The assets, which may include support documentation, instructional content, onboarding materials, and training modules, are dynamically updated to reflect the latest UI configurations. This ensures that all forms of user assistance whether provided through real-time interactions, training resources, or knowledge bases remain current and relevant. By continuously synchronizing support assets with the evolving platform interface, the system enhances the reliability and effectiveness of user guidance, ensuring consistency across all support channels.

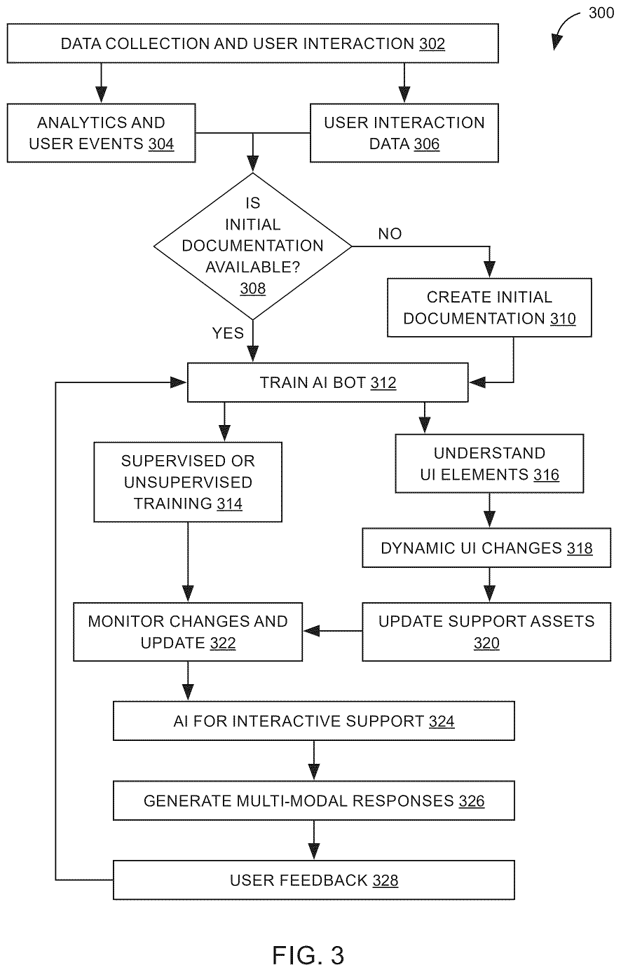

FIG. 3 is a flowchart 300 illustrating an example process for training the artificial intelligence (AI)-driven user support system 100 of FIG. 1 according to embodiments of the invention. The process is initiated by activating the core components of the system required for data collection and user interaction 302. This setup ensures that the system is prepared to track, analyze, and respond to user activities on the platform.

Data collection is a crucial step, involving two primary sources: analytics and usage events 304, that provide insights into user navigation patterns and feature utilization, and user interaction data 306, that includes direct engagement metrics such as queries and feedback. Together, these data sources provide a comprehensive understanding of user behaviour, preferences, and support needs.

Following data collection, the system verifies the availability of initial support documentation 308. If sufficient support assets, such as help articles, FAQs, or tutorials, exist, the system proceeds to the AI training phase 312. In cases where documentation is lacking, the system autonomously generates the necessary initial documents 310 to ensure users are adequately supported.

The AI bot training 312 involves the AI-driven support module undergoing supervised or unsupervised training 314 based on the collected data. This training enables the AI to improve its contextual understanding, response accuracy, and predictive abilities. Simultaneously, the system learns to recognize and interpret user interface (UI) elements 316, enhancing its ability to provide context-aware guidance. The training process ensures that the AI is equipped to interpret varying user inputs and UI changes accurately.

The system continuously monitors the platform for dynamic UI changes 318 that could affect the relevance and effectiveness of the support assets. If the system detects changes, such as the relocation of buttons, the addition of new features, or modifications to the UI layout, it adjusts the corresponding support assets 320 such as help documentation, tooltips, or visual guides accordingly. These updates ensure that the system's support resources remain aligned with the current state of the platform, thereby improving user satisfaction and reducing potential confusion.

As part of its ongoing training and optimization, the AI-driven support module incorporates new features by monitoring platform updates 322 and system modifications. These changes are reflected in the AI's knowledge base and support materials 324, ensuring that the AI remains current with the platform's evolving capabilities. The system generates multi-modal responses 326, providing user support in various formats such as text-based answers, visual guides, interactive tutorials, or a combination thereof.

AI for interactive support 324 allows the system to engage users in real-time, leveraging its trained capabilities to assist with immediate queries and challenges. User feedback 328 is a vital component of the process, enabling continuous improvement of the system. Feedback is integrated into the AI's training, refining its responses and enhancing its ability to meet user needs effectively. The process concludes with a fully trained AI system, capable of delivering dynamic and personalized support to users.

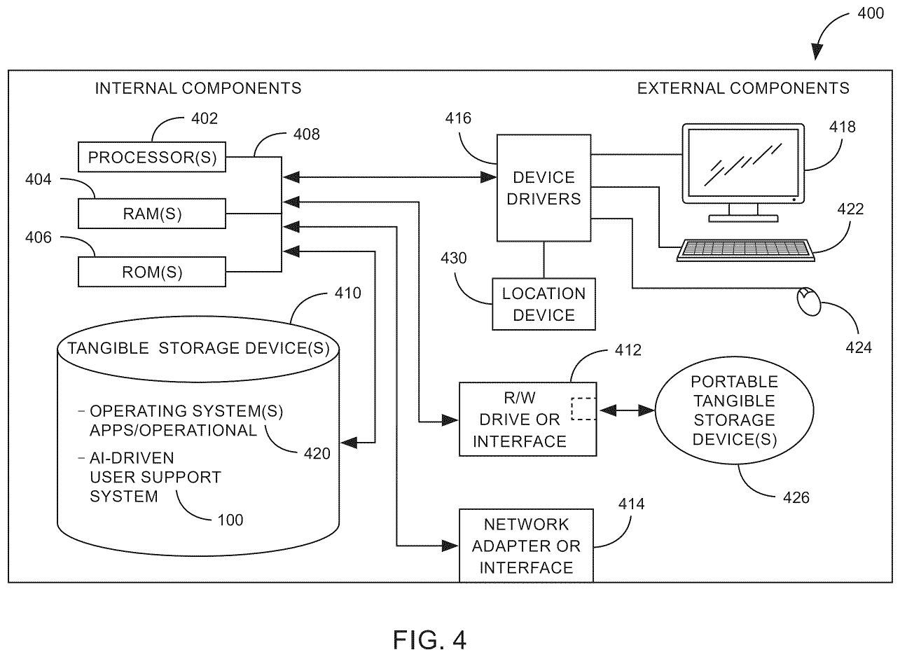

The modules of the AI-driven user support system 100, described herein, are implemented in computing devices to facilitate user assistance and task execution. One example of a computing device 400 is described below in FIG. 4. The computing device 400 includes one or more processor(s) 402, one or more computer-readable RAMs 404, and one or more computer-readable ROMs 406 on one or more buses 408. Further, the computing device 400 includes a tangible storage device 410 that may be used to execute operating systems 420 and the AI-driven user support system 100. The various modules of the AI-driven user support system 100 may be stored in the tangible storage device 410. Both, the operating systems 420 and the AI-driven user support system 100 are executed by one or more processor(s) 402 via one or more respective RAMs 404 (which typically include cache memory). The execution of the operating systems 420 and/or the AI-driven user support system 100 by the one or more processor(s) 402, configures the one or more processor(s) 402 as a special purpose processor configured to carry out the functionalities of the operation systems 420 and/or the AI-driven user support system 100 as described above.

Examples of tangible storage devices 410 include semiconductor storage devices such as ROM, EPROM, flash memory, or any other computer-readable tangible storage device that may store a computer program and digital information.

The computing device 400 also includes an R/W drive or interface 414 to read from and write to one or more portable computer-readable tangible storage devices 428 such as a CD-ROM, DVD, memory stick, or semiconductor storage device. Further, network adapters or interfaces 412 such as TCP/IP adapter cards, wireless Wi-Fi interface cards, or 3G or 4G wireless interface cards, or other wired or wireless communication links are also included in computing devices.

In one example embodiment, the AI-driven user support system 100 may be stored in the tangible storage device 410 and may be downloaded from an external computer via a network (for example, the Internet, a local area network, or other, wide area network) and network adapter or interface 412.

Computing device 400 further includes device drivers 416 to interface with input and output devices. The input and output devices may include a computer display monitor 418, a keyboard 422, a keypad, a touch screen, a computer mouse 424, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or its uses. The broad teachings of the disclosure may be implemented in a variety of forms. Therefore, while this disclosure includes particular examples, the true scope of the disclosure should not be so limited since other modifications will become apparent upon a study of the drawings, and the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example, flash memory devices, erasable programmable read-only memory devices, or mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

We claim:

1. An artificial intelligence (AI)-driven user support system for a platform,
wherein the system comprises:
at least one user interface configured to facilitate user interaction of a user with the system, wherein the user interface is further configured to receive user inputs corresponding to a desired task to be performed on the platform;
an AI-driven support module configured to provide support to the user in response to the user inputs; and
an AI training module configured to:
track real-time user interaction data of the user with the AI-driven support module ;
track analytics and application usage data of the platform; and
facilitate real-time training of the AI-driven support module based upon the tracked user interaction data and analytics and application usage data and website design and structure to provide multi-modal support to the user.

2. The AI-driven user support system of claim 1, wherein the AI training module is further configured to train the AI-driven support module via supervised or un-supervised model.

3. The AI-driven user support system of claim 2, wherein the AI training module is further configured to monitor dynamic changes to the at least one user interface and to update support documentation for the AI-driven support module.

4. The AI-driven user support system of claim 3, wherein the AI training module is further configured to determine context and functionalities of the at least one user interface and update support assets of the AI-driven support module.

5. The AI-driven user support system of claim 2, wherein the AI training module is further configured to monitor changes corresponding to addition of new features to the AI-driven support module based on the tracked analytics and application usage data and to update support documentation for the AI-driven module.

6. The AI-driven user support system of claim 1, wherein the AI training module is further configured to monitor and learn from access-controlled interfaces, distinguishing between admin level and user level interfaces.

7. The AI-driven user support system of claim 1, wherein the AI training module is further configured to receive feedback from the user and to train the AI-driven support module based upon the received feedback.

8. The AI-driven user support system of claim 1, wherein the AI-driven support module is configured to provide text response, visual guide response, or combinations thereof in response to the user input.

9. The AI-driven user support system of claim 8, wherein the AI-driven support module is configured to provide the responses corresponding to one or more changes to the at least one user interface.

10. The AI-driven user support system of claim 1, wherein the AI training module is further configured to dynamically update the platform's onboarding experience based on changes to one or more user interface elements.

11. The AI-driven user support system of claim 10, wherein the dynamic updates include modifying onboarding content, tooltips, guides, or instructional elements in real-time to correspond to the changes in the user interface.

12. An artificial intelligence (AI)-driven user support system for a platform,
wherein the system comprises:
a memory storing one or more processor-executable routines; and
a processor communicatively coupled to the memory, the processor configured to execute the one or more processor-executable routines to:
receive user inputs corresponding to a desired task to be performed on the platform via at least one user interface;
provide support to the user in response to the user inputs via an AI-driven support module ;
track real-time user interaction data and analytics and application usage data of the platform; and
train the AI-driven support module via an AI training module based upon the tracked user interaction data and analytics and application usage data and website design and structure to provide multi-modal support to the user.

13. The AI-driven user support system of claim 11, wherein the AI training module is further configured to train the AI-driven support module via supervised or un-supervised model.

14. The AI-driven user support system of claim 11, wherein the AI-driven support module is configured to provide context-aware support to the user.

15. The AI-driven user support system of claim 11, wherein the AI-driven support module is configured to:
detect one or more changes to one or more user interfaces of the system; and
provide responses to the user inputs, wherein the responses correspond to the changes to the one or more user interfaces.

16. The AI-driven user support system of claim 11, wherein the provided responses comprise text response, visual guides, interactive responses, or combinations thereof.

17. The AI-driven user support system of claim 11, wherein the AI-driven training module is further configured to monitor changes corresponding to addition of new features to the AI-driven support module based on the tracked analytics and application usage data and to update support documentation for the AI-driven support module.

18. The AI-driven user support system of claim 11, wherein the AI training module is further configured to monitor and learn from access-controlled interfaces, distinguishing between admin level and user level interfaces.

19. The AI-driven user support system of claim 11, wherein the AI training module is further configured to receive feedback from the user and to train the AI-driven support module based upon the received feedback.

20. The AI-driven user support system of claim 11, wherein AI training module is further configured to update one or more assets of the system based upon the changes to the user interfaces.

21. A method for training an artificial intelligence (AI)-driven user support system, the method comprising:
interacting with a user of the system via at least one user interface;
providing responses to the user in response to one or more user inputs received via the user interface;
tracking real-time user interaction data of the user;
tracking analytics and application usage data of the system; and
dynamically training the system based upon the tracked user interaction data and analytics and application usage data.

22. The method of claim 21, further comprising providing multi-modal support to the user in response to the user inputs.

23. The method of claim 21, further comprising:
detecting one or more changes to one or more user interfaces of the system;
adjusting responses corresponding to the one or more changes to one or more user interfaces; and
providing responses to the user inputs.

24. The method of claim 21, further comprising updating one or more assets of the system based upon the changes to the user interfaces.

25. The method of claim 21, further comprising providing text response, visual guides, interactive responses, or combinations thereof to the user.
